(19) United States
(12) Patent Application Publication
(10) Pub. No.: US 2010/0195803 A1
(43) Pub. Date: Aug. 5, 2010

(54) RADIOGRAPHIC RECEPTOR SECURING AND POSITIONING APPARATUS

(75) Inventors: Jarrid L. Henderson, Pittsburgh, PA (US); Jeremy B. Hoover, Meyersdale, PA (US)

Correspondence Address: IN-IP Law Group, P.C., 100 Technology Drive, Suite 400, Pittsburgh, PA, 15219, US

(73) Assignee: J2 Medical Solutions LLC, Pittsburgh, PA (US)

(21) Appl. No.: 12/629,856

(22) Filed: Dec. 2, 2009

Related U.S. Application Data
(60) Provisional application No. 61/200,524, filed on Dec. 2, 2008.

(51) Int. Cl. G03C 5/16; H01J 31/50

(52) U.S. Cl. 378/167; 378/189; 250/361 R

(57) ABSTRACT

A radiographic securing and positioning apparatus has a support structure having a securing portion and a mounting portion. The securing portion includes a base configured to support a radiographic receptor on one side and securing extensions configured to support a radiographic receptor on at least one set of opposing surfaces. The mounting portion may also support the securing portion for mounting the apparatus to a table.

### CROSS REFERENCE TO RELATED APPLICATION

This application claims the benefit of priority of U.S. Provisional Patent Application Ser. No. 61/200,524, filed Dec. 2, 2008, which is incorporated herein by reference in its entirety.

### BACKGROUND OF THE INVENTION

1. Field of the Invention

The present invention relates generally to radiography and related receptor holding devices, and, more particularly, to a radiographic receptor securing and positioning apparatus that allows for efficient securing of a radiographic receptor in an area of interest for selectively positioning the radiographic receptor relative to a radiography target.

2. Description of Related Art

Various procedures in the medical field and otherwise, use radiography to produce images for assessing radiopaque materials. These images are often stored on radiographic receptors such as, for example, film cassettes, CR-plates, DR-panels, etc. One example of such imaging is the use of radiography in taking of orthopedic x-rays. An x-ray machine must be calibrated and appropriately aligned with respect to the receptor in order to appropriately scale the joint and bone structure of the patient.

It is well known that problems often arise when attempting to keep the receptor plate in place during the x-ray process in relation to the x-ray machine. Patients often lie on a horizontal or vertical table throughout the duration of the x-ray so options are limited for placement of the vertical pole mount without additional securing and positioning capabilities. In situations where “non-traditional” holding is required, technicians may have to use props or other makeshift devices to hold the receptor in a desired position with respect to the x-ray machine. Further, space in any medical environment must be kept safe and securing instruments in such an environment assists in keeping such environments safe.

Other problems arise where an image may not be properly acquired due to insufficient and/or faulty receptor positioning, wherein additional imaging on the same patient may be required adding to the costs and time of the procedure as well as additional exposure of radiation to the patient. Further, repeats are problematic in that they indicate imaging technicians need further training adding expense. Some studies show that even the best imaging technologists have a repeat rate of about 7% using current methods and devices to obtain accurate images which adds to costs and inefficiencies.

According to the prior art, most solutions currently available to the market include receptor holders made of simple opposing channel stock that is slidably mounted to a vertical pole, and hand tightened to the vertical pole via a screw. These stationary poles must be placed near the area of interest in order for the receptor to receive the image cast by the x-ray. One problem with current positioning equipment is that it may be generally uncomfortable for both the patient and the technician to physically position the radiography target of the patient to comport with the desired positioning of the receptor. Another issue that commonly arises is that the receptor holder is not secured and may be misplaced, knocked over or otherwise create an unnecessary hazard in the medical environment.

### SUMMARY OF THE INVENTION

Accordingly, it is one object of the present invention to provide a radiographic receptor securing and positioning apparatus that overcomes many of the drawbacks and deficiencies of the prior art systems and arrangements. It is another object of the present invention to provide a radiographic receptor securing and positioning apparatus that permits efficient securing of a radiographic receptor in an area of interest for selectively positioning the radiographic receptor with respect to a radiographic target of a patient.

In accordance with the present invention, provided is a radiographic receptor securing and positioning apparatus for supporting a radiographic receptor. The radiographic securing and positioning apparatus may include a support structure configured to selectively position and support a radiographic receptor on at least one set of opposing surfaces and one side of the radiographic receptor.

In accordance with the present invention, provided is a radiographic securing and positioning apparatus having a support structure with a securing portion and a mounting portion. The securing portion includes a base configured to support a radiographic receptor on one side and securing extensions configured to support a radiographic receptor on at least one set of opposing surfaces. The mounting portion may also support the securing portion.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended to unduly limit the present invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of an embodiment of a radiographic receptor securing and positioning apparatus in accordance with the present invention;

FIG. 2 is a front view of at least a portion of a securing portion of an embodiment of a radiographic receptor securing and positioning apparatus in accordance with present invention;

FIG. 3 is a front perspective view of at least a portion of a securing portion of an embodiment of a radiographic receptor securing and positioning apparatus in accordance with present invention;

FIG. 4 is a rear perspective view of at least a portion of the radiographic receptor securing and positioning apparatus shown in FIG. 3;

FIG. 5 is a side perspective view of an embodiment of a radiographic receptor securing and positioning apparatus supporting a radiographic receptor in accordance with present invention;

FIG. 6 is a top view of the radiographic receptor securing and positioning apparatus shown in FIG. 5;

FIG. 7 is a rear perspective view of the radiographic receptor securing and positioning apparatus shown in FIG. 5;

FIG. 8 is a side view of the radiographic receptor securing and positioning apparatus shown in FIG. 5;

FIG. 9 is a side perspective exploded view of positioning references of a radiographic receptor securing and positioning apparatus in accordance with the present invention; and

FIG. 10 is a perspective view of embodiments of radiographic receptor securing and positioning apparatuses in accordance with the present invention.

### DESCRIPTION OF THE PREFERRED EMBODIMENT(S)

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as unduly limiting.

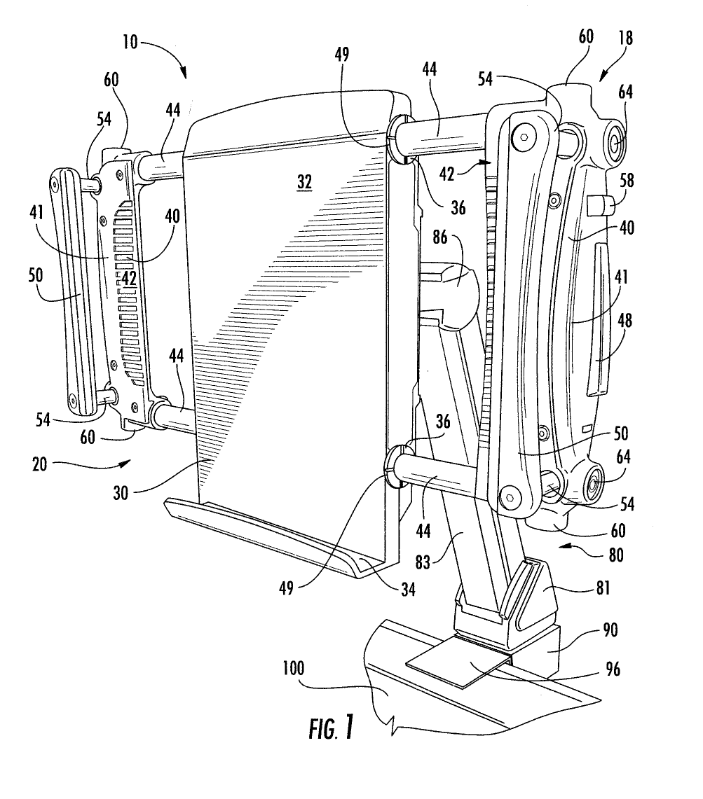

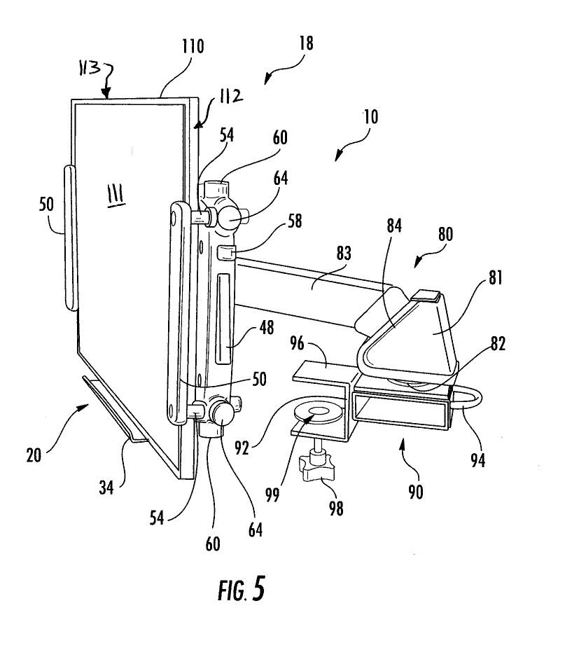

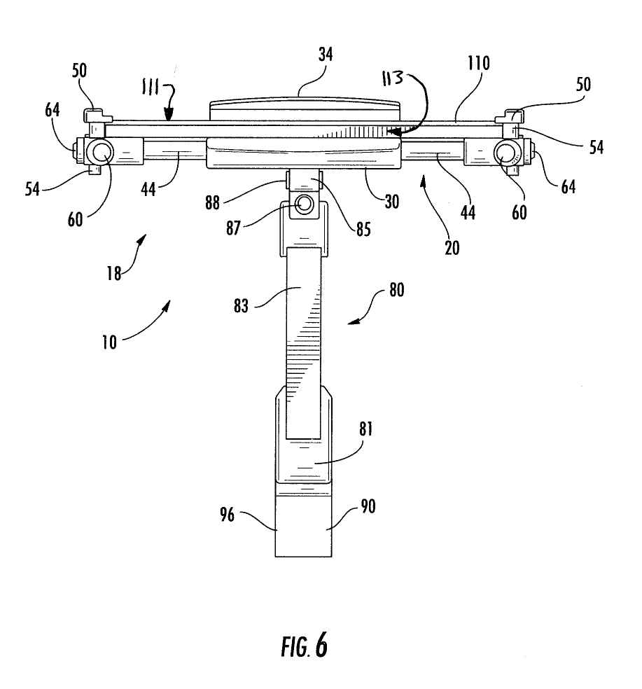

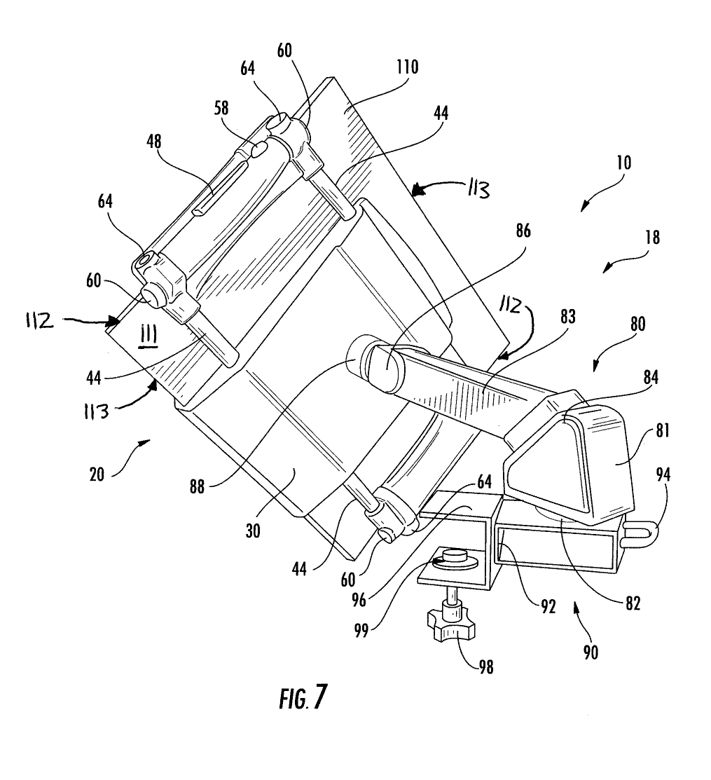

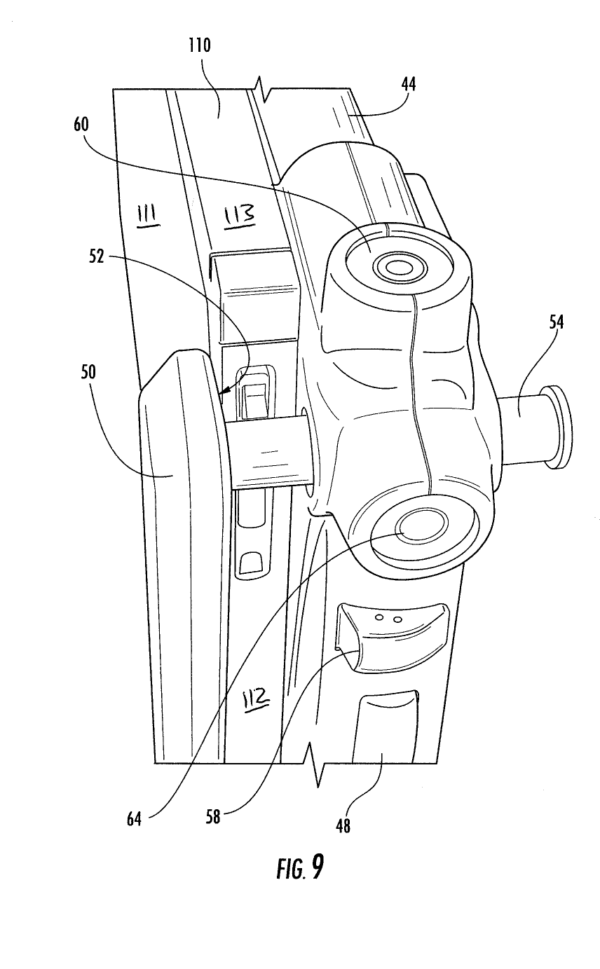

The present invention is directed to a radiographic receptor securing and positioning apparatus (“RRSP apparatus”) 10, which is illustrated in various preferred and non-limiting embodiments in FIGS. 1-10. The RRSP apparatus 10 includes a support structure 18 for supporting and selectively positioning (or orienting) a radiographic receptor 110 with respect to a radiographic target, such as a patient, for example. As shown in FIGS. 5-10, radiographic receptors 110 are generally thin rectangular cube shaped objects typically having three opposing surfaces 111, 112, 113 and may comprise, for example, film cassettes, CR-plates, DR-panels, etc.

The support structure 18, in one preferred non-limiting embodiment as shown in FIG. 1, includes a securing portion 20, a positioning portion 80 and a mounting portion 90. The securing portion 20 may support and releasably secure the radiographic receptor 110 to the support structure 18. As discussed hereinafter, the positioning portion 80 may take a variety of forms for selectively positioning and orienting the RRSP apparatus 10 in a desired area of interest with respect to the patient. The mounting portion 90 may also take a variety of forms for securing the RRSP apparatus 10 to a table 100 or other mounting support as required for a given application such as, for example, a vertical support (not shown) of a traditional stand.

The securing portion 20 of the support structure 18 may further support and releasably secure the radiographic receptor 110 in an area of interest near a radiography target such as, for example, the femoral bone of a patient being x-rayed. Further, the securing portion 20 may include base 30, longitudinal securing extensions 40, and securing extensions 50. The positioning portion 80 may comprise multiple joints, knuckles and arms (81-89) as discussed in greater detail below. The mounting portion 90 may be provided to allow additional releasable positioning and attachment to the table 100 for securing the RRSP apparatus 10 in a stable state and orientation.

As shown in FIGS. 1, 5-8 and 10, the base 30 provides a receiving surface 32 that may allow the radiographic receptor 110 to rest thereon prior to and during engagement by the securing extensions 50. Further, base 30 may be provided with a tray 34 wherein the radiographic receptor 110 may rest upon prior to and during engagement by the securing extensions 50. In addition, base 30 may be provided with apertures 36 and may further be separable acting as a covering for portions of the longitudinal securing extensions 40. Accordingly, portions of the longitudinal securing extensions 40 may pass through and/or engage apertures 36. Although the tray 34 is shown in a channel configuration, it will be understood by one skilled in the art that other configurations, shapes and arrangements may be used to effectively support a radiographic receptor 110 within the spirit and scope of the invention.

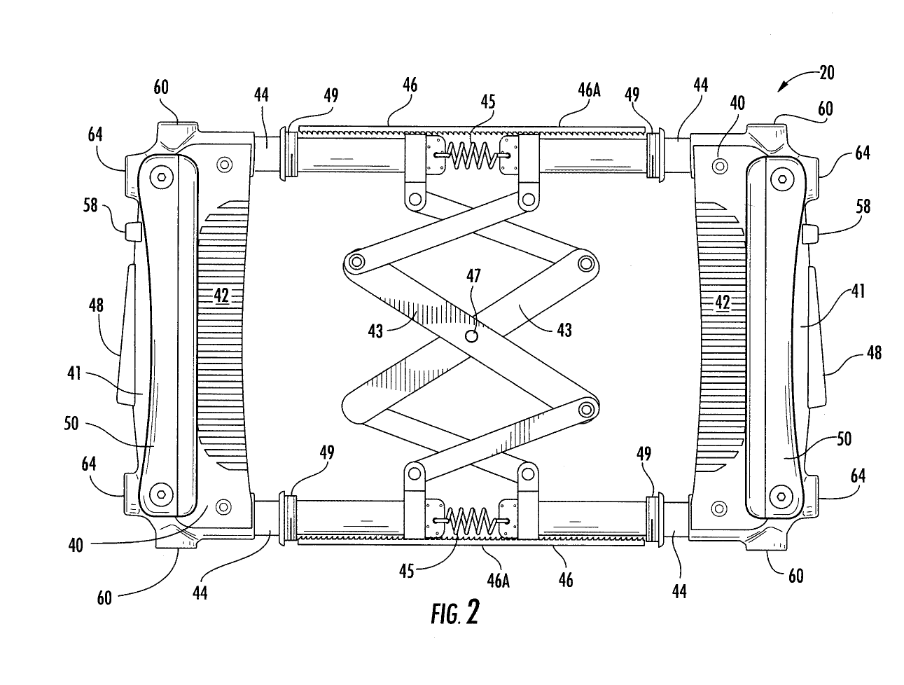

The longitudinal securing extensions 40 may include handles 41 having a receiving surface 42 formed therein as shown in FIGS. 1 and 2, for example, as well as a release portion 48 positioned therein. Accordingly, a user may grasp the RRSP apparatus 10 about the handles 41 with their palms facing the release portion 48 and fingers extending behind the longitudinal securing extensions 40 in relation to the receiving surface 42. When a radiographic receptor 110 is introduced onto the RRSP apparatus 10, the receptor 110 may thus rest on receiving surface 42 before and after being releasably secured by the securing extensions 50.

The longitudinal securing extensions 40 may also have traveling members 44 in communication with the base 30 that are selectively positionable to maintain and hold a desired position for securing a radiographic receptor 110 between the securing extensions 50. See FIGS. 5-10. Such traveling members 44 of the longitudinal securing extensions 40 may have a nested telescoping arrangement, solid arrangement or otherwise in accordance with the present invention.

Depending upon the application of the medical procedure, varying holding forces may be desire and/or required. Accordingly, where a small force is required to secure a lightweight radiographic receptor 110 between the securing extensions 50 on either side of the base 30, the traveling members 44 may be held in place by a grommet 49 causing sufficient friction to limit the movement of the traveling members 44 in relation to the base 30 and hold the traveling members 44 in place. Alternatively, other holding portions 46 may be employed as shown in FIGS. 2-4, for example, and described in more detail hereinbelow.

In a similar fashion, although securing another portion of the radiographic receptor 110, the securing extensions 50 may be selectively positionable to maintain and hold a desired position for securing the radiographic receptor 110 between the securing extensions 50 as shown in FIGS. 5-10. The securing extensions 50 may include a retaining surface 52 somewhat opposed to the receiving surface 42 for holding the radiographic receptor 110 therebetween.

The securing extensions 50 may further include traveling members 54 for adjusting the position of the retaining surface 52 in relation to the handles 41, wherein traveling members 54 may be positioned through the handle 41 or otherwise in communication with the longitudinal securing extensions 40. Such traveling members 54 of the securing extensions 50 may have a nested telescoping arrangement, solid arrangement or otherwise in accordance with the present invention.

Depending upon the application of the medical procedure, varying holding forces may be desire and/or required. Accordingly, where a small force is required to secure a lightweight radiographic receptor 110 between the respective securing extensions 50 and handles 41, the traveling members 54 may be held in place by a grommet (not shown) internal to the handle 41, causing sufficient friction to limit the movement of the traveling members 54 in relation to the receiving surface 42. Alternatively, holding portions 56 may be employed as shown in FIGS. 2-4, for example, and described in more detail hereinbelow.

One preferred and non-limiting embodiment of a holding portion 46 of the longitudinal securing extensions 40 is shown in FIGS. 2-4. The holding portion 46 may be selectively positionable to maintain and hold a desired position for securing the radiographic receptor 110 between the securing extensions 50 using a ratcheting arrangement. Alternatively, in accordance with the present invention, the holding portion 46 may include a spring loaded pin holding system wherein the pins may be aligned with apertures to match dimensions of select radiographic receptors 110. Each traveling member 44 may be in communication with a rack 46A via a pawl mechanism 46B that performs the ratcheting arrangement. Accordingly, as each traveling member 44 is positioned closer to one another inside the base 30, which houses these mechanisms between grommets 49 that are in communication with base 30, the pawl mechanism 46B secures into successive teeth on the rack 46A holding the handles 41 in a desired position. Accordingly, a large force would be required to reverse the holding portion 46 as shown in FIGS. 2-4.

In addition, a biasing member 45 may be optionally included to bias the traveling members 44 either away from one another, creating a normally open arrangement, or toward one another, creating a normally closed arrangement. Such biasing member 45 may be a spring, as shown in FIG. 2, for example, or other mechanism to assist the user in using the RRSP apparatus 10.

As shown in FIGS. 2-5, the longitudinal securing extensions 40 of the securing portion 20 may include linkages 43 for enhancing the travel characteristics of the longitudinal securing extensions 40. Further, the linkages 43 may be in communication via pin 47. The linkage 43 may thus regulate the travel of the longitudinal securing extensions 44 as a user pulls on each handle 41 with separate hands with separate forces being applied. Such travel is important in maintaining a predictable location of the radiographic receptor 110 as it is being secured to the RRSP apparatus 10 for obtaining an image.

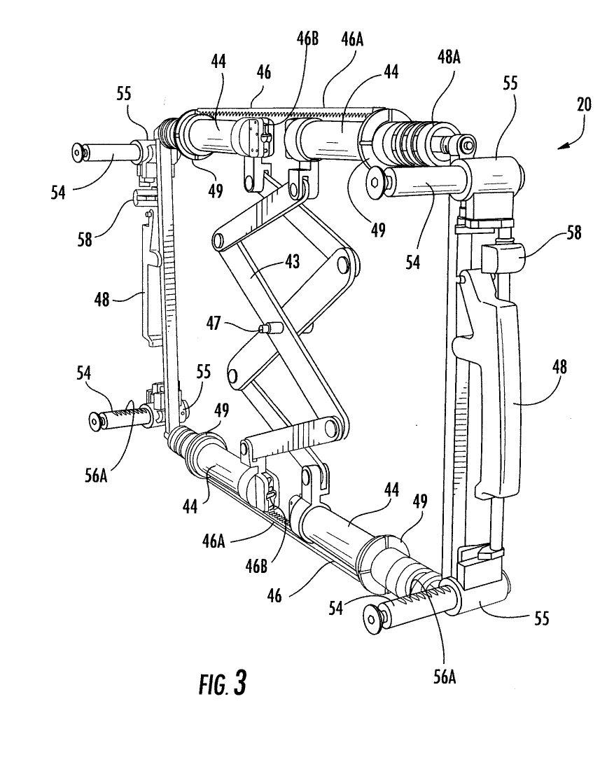

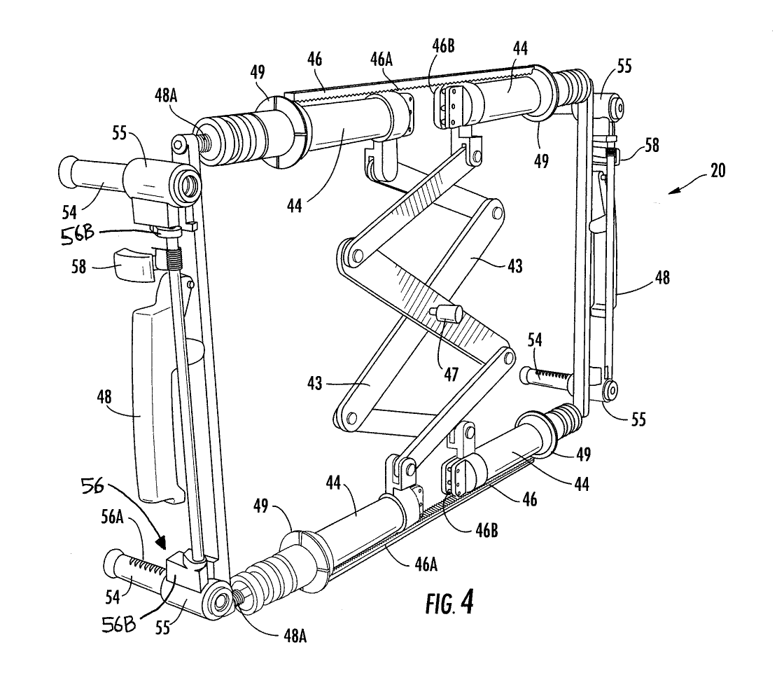

As shown in greater detail in FIGS. 3 and 4, the securing extensions 50 may include housings 55 wherein traveling members 54 are supported thereby. Holding portion 56 of the securing extensions 50 may thus be selectively positionable to maintain and hold a desired position for securing the radiographic receptor 110 between the respective securing extensions 50 and the handles 41 using a ratcheting arrangement. More specifically, each holding portion 56 may include a rack 56A and a pawl mechanism 56B internal to the housing 55, that performs the ratcheting arrangement. Accordingly, as each retaining surface 52 of the securing extension 50 is positioned closer to the respective handle 41 and through the housing 55, the pawl mechanism 56B secures into successive teeth on the rack 56A holding the securing extension 50 in a desired position. Accordingly, a large force would be required to reverse the holding portion 56 as shown in FIGS. 5-10 away from the handle 41. Alternatively, in accordance with the present invention, the holding portion 56 may include a spring loaded pin holding system wherein the pins may be aligned with apertures to match dimensions of select radiographic receptors 110.

One preferred and non-limiting embodiment utilizes the release portion 48 to disengage the pawl mechanism 46B and permit the traveling members 44 to be positioned away from one another again. Accordingly, when the user grasps the handle 41 and depresses the release portion 48, a plunger 48A may be activated causing the pawl mechanism 46B to be released from engagement with the rack 46A. The release portion 48 may be biased to an initial state via springs or other biasing members such that the home position is resumed after a user depresses and relieves the release portion 48.

In a similar fashion, and as shown in FIG. 4, for example, a release portion 58 may disengage the pawl mechanism 56B from the rack 56 once activated by the user. Thus, the release portion 56 may permit the retaining surface 52 to be positioned away from the handle 41 in order to release the radiographic receptor 110 or otherwise to reposition the securing extension 50. Again, like the release portion 48, release portion 58 may be biased to an initial state via springs or other biasing members such that the home position is resumed after a user depresses the relieves the release portion 58.

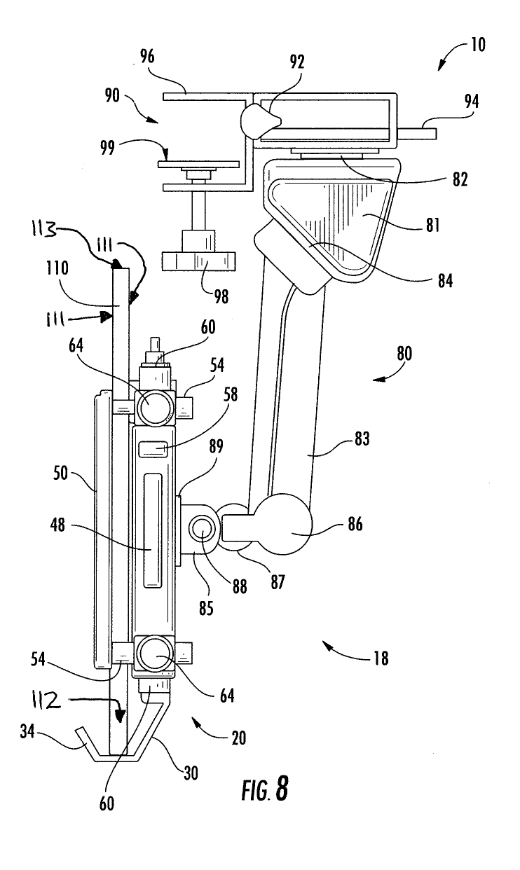

In one preferred and non-limiting embodiment the present invention, and as illustrated in FIG. 8, for example, has a positioning portion 80 that may include a first joint 82 in articulating communication with a mounting portion, a first knuckle 81 in articulating communication with the first joint 82, a second joint 84 in articulating communication with the first knuckle 81, an arm 83 in articulating communication with the second joint 84, a third joint 86 in articulating communication with the arm 83, a fourth joint 87 in articulating communication with the third joint 86, a fifth joint 88 in articulating communication with the fourth joint 87, and a sixth joint 89 in articulating communication with the fifth joint 88. Although various joints and ankles of the present invention are in articulating communication about one axis with one another, it is contemplated within the scope of the present invention to provide multi-axial joint in place of single axis joints or multi-positional structures with an infinite number of configurations. Accordingly, the RRSP apparatus 10 can be positioned in multi-planar configurations and orientations as show in FIGS. 5-8 and 10.

More specifically, arm 83, and thus securing portion 20, may be selectively repositionable as illustrated in FIGS. 5-8 and 10 above the table 100, out from the table 100, at a horizontal angle to the table 100, below the table 100, at a vertically inclined angle to the table 100, flush with the surface of the table 100, etc. Further, arm 83 and the interconnected joints (82, 84, 86, 87, 88, 89) and knuckles (81, 85) may position the radiographic receptor in a stable manner via gas assist positioning or other stabilizing mechanisms. Thus, the positioning portion is preferably movable and/or maneuverable in relation to the table 100 and can be maneuvered into and secured in many positions as shown in FIGS. 5-8 and 10.

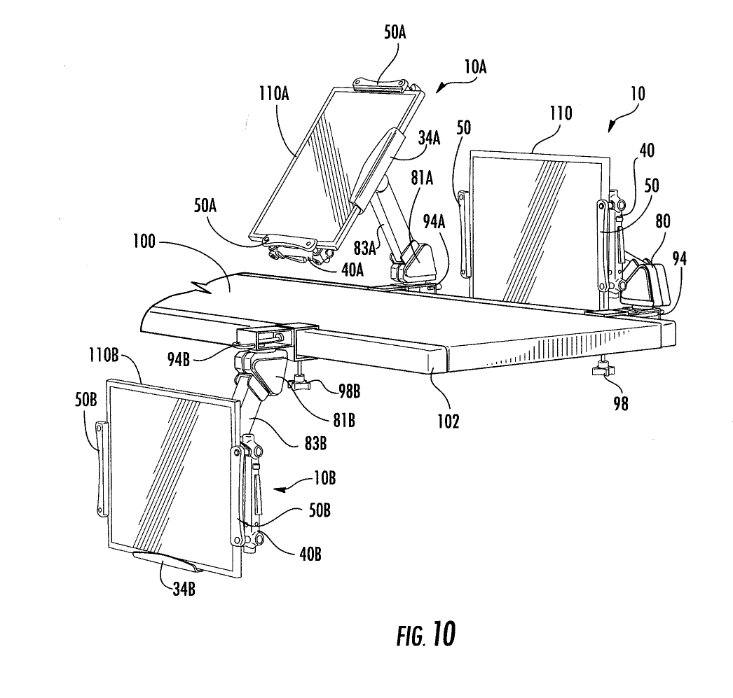

The positioning portion 80 may further be in communication with the mounting portion 90 as shown in FIGS. 1, 5-8 and 10. The mounting portion 90 may include a seventh joint 92 permitting the RRSP apparatus 10 to rotate above and below the table 100 as shown in FIG. 10. Further, mounting portion 90 may have a release portion 94 that permits the mounting portion to permit rotation when activated by a user and return to a stable state when released by the user. Mounting portion 90 may further be secured to a table 100 via a securing mechanism 98 having a receiving portion 96 and a securable surface 99. The securable surface 99 of securing mechanism 98 may threadedly engage the table 100 or a channel 102 of the table 100 when rotated by a user. Accordingly, the RRSP apparatus 10 may remain affixed to the table 100 and/or channel 102 via the mounting portion 90. Although the present embodiment discusses a threaded engagement of the RRSP apparatus 10 via mounting portion 90 to table 100 and/or channel 102, other releasable mounting devices are contemplated herein within the spirit and scope of the invention.

As can be seen in FIGS. 1, 5-10, first positioning references 60 are generally paired up on the top of the RRSP apparatus 10 while second positioning references 64 are generally paired up on sides of the RRSP apparatus 10. Positioning references 60, 64 may include a number of indicators to inform the user of the RRSP apparatus 10 of the relative position of the RRSP apparatus 10 including, but not limited to, bubble levels. Thus, positioning references may be paired on a similar side of the RRSP apparatus 10 in order to inform the user of the vertical and horizontal position regardless of the rotation orientation of the RRSP apparatus 10.

Accordingly, the present invention provides a radiographic receptor securing and positioning apparatus 10 that allows for the selective positioning of a radiographic receptor 110 with respect to a target area of a patient. Through the use of the novel support structure 18 as described herein, the radiographic receptor securing and positioning apparatus 10 does not need to be brought to and from the patient for each and every image taken, does not need to be untightened and tightened to secure the radiographic receptor 110 on two sides, does not require the patient to adjust as much to the imaging angle, while allowing for the efficient securing and release of the radiographic receptor 110. Instead, the present invention provides a unique arrangement and apparatus for effectively and efficiently engaging in radiographic procedures using a selectively positioned and oriented radiographic receptor securing and positioning apparatus 10.

Although the invention has been described in detail for the purpose of illustration based on what is currently considered to be the most practical and preferred embodiment(s), it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. Since other modifications and changes varied to fit particular operating requirements and environments will be apparent to those skilled in the art, the invention is not considered limited to the example chosen for purposes of disclosure, and covers all changes and modifications which do not constitute departures from the spirit and scope of this invention.

The invention claimed is:

1. A radiographic receptor securing and positioning apparatus for supporting a radiographic receptor, comprising:
a support structure configured to selectively position and support a radiographic receptor on at least one set of opposing surfaces and one side of the radiographic receptor.

2. The radiographic receptor securing and positioning apparatus of claim 1, wherein said support structure comprises a securing portion having a base configured to support the radiographic receptor on the one side.

3. The radiographic receptor securing and positioning apparatus of claim 2, wherein the base further comprises a tray configured to support the radiographic receptor on another side adjacent the one side.

4. The radiographic receptor securing and positioning apparatus of claim 2, wherein said securing portion comprises at least one set of securing extensions configured to support the radiographic receptor on the at least one set of opposing surfaces.

5. The radiographic receptor securing and positioning apparatus of claim 4, wherein said at least one set of securing extensions are configured to releasably ratchet toward the base.

6. The radiographic receptor securing and positioning apparatus of claim 4, wherein each said securing extension of said at least one set of securing extensions are configured to releasably ratchet toward another said securing extension.

7. The radiographic receptor securing and positioning apparatus of claim 6, wherein said at least one set of securing extensions have a receiving surface configured to support the radiographic receptor on the one side.

8. The radiographic receptor securing and positioning apparatus of claim 6, wherein said at least one set of securing extensions comprise a release portion configured to release the securing extensions for travel away from another said securing extension.

9. The radiographic receptor securing and positioning apparatus of claim 6, wherein each securing extension of said at least one set of securing extensions are in communication with at least one linkage.

10. The radiographic receptor securing and positioning apparatus of claim 6, wherein each securing extension of said at least one set of securing extensions are in communication with a biasing member.

11. The radiographic receptor securing and positioning apparatus of claim 4, wherein said support structure further comprises a positioning portion configured to support the support structure and position the radiographic receptor in various orientations about multiple axes.

12. The radiographic receptor securing and positioning apparatus of claim 11, wherein said support structure further comprises a mounting portion configured to support the positioning portion.

13. The radiographic receptor securing and positioning apparatus of claim 12, wherein the mounting portion comprises a securing mechanism configured to be secured to a table.

14. A radiographic receptor securing and positioning apparatus for supporting a radiographic receptor, comprising:
a support structure having a securing portion and a mounting portion, wherein the securing portion comprises:
a base configured to support a radiographic receptor on one side; and
a first set of securing extensions configured to support a radiographic receptor on at least one set of opposing surfaces, and wherein the mounting portion supports the securing portion.

15. The radiographic receptor securing and positioning apparatus of claim 14, wherein the securing portion further comprises a second set of securing extensions configured to support a radiographic receptor on at least another set of opposing surfaces.
